(19) United States
(12) Patent Application Publication
(10) Pub. No.: US 2025/0076128 A1
(43) Pub. Date: Mar. 6, 2025

(54) LOW ACTIVITY, SPATIAL CALIBRATION FOR FULL DIGITAL DOMAIN THERMAL SENSORS

(71) Applicant: NVIDIA Corporation, Santa Clara, CA (US)

(72) Inventors: Ofek Abadi, Nahariya (IL); Naor Peretz, Kfar Yona (IL)

(21) Appl. No.: 18/239,902

(22) Filed: Aug. 30, 2023

(51) Int. Cl. G01K 15/00; G01K 1/02; G01K 7/00

(52) U.S. Cl. CPC G01K 15/005; G01K 1/026; G01K 7/00

(57) ABSTRACT

An integrated circuit includes a plurality of thermal sensors integrated within digital domain circuitry and powered by a digital supply voltage. An activation register receives activation data from a tester unit. Control logic, in response to the activation register being written with the activation data, enters a thermal calibration mode, deactivates a plurality of digital logic units of the digital domain circuitry, and causes a reference clock received from the tester to drive the plurality of the thermal sensors.

### TECHNICAL FIELD

At least one embodiment generally pertains to integrated circuits (ICs) or IC dice, and more specifically, but not exclusively, to low activity, spatial calibration for full digital domain thermal sensors.

### BACKGROUND

In many applications in which integrated circuits (ICs) or IC dice operate, there are system requirements for real-time thermal reads from digital domain areas within the ICs. Thermal sensors that operate on the same digital power supply as the digital units are used for this purpose. Due to global and local variations in the silicon production (among other material processes), the accuracy of the thermal readings of the thermal sensors is degraded. This accuracy degradation is common for any thermal sensor inside an IC die. The level of accuracy degradation depends on the architecture and design of the thermal sensors.

### BRIEF DESCRIPTION OF DRAWINGS

Various embodiments in accordance with the present disclosure will be described with reference to the drawings, in which:

FIG. 1 is a schematic block diagram of an example thermal testing system implementing low activity, spatial calibration for full digital domain thermal sensors according to various embodiments;

FIG. 2 is a graph illustrating inaccuracies with common approaches to thermal calibration;

FIG. 3 is a schematic block diagram of an example system architecture for reading thermal calibration diodes according to at least some embodiments;

FIG. 4 is a simplified schematic block diagram of an example set of IC dice together with a spatial grouping of thermal sensors and associated calibration diodes according to at least some embodiments;

FIG. 5 is a pair of graphs illustrating the motivation for spatially grouping sensors in particular ways according to various embodiments; and

FIG. 6 is a flow chart of an example method for determining a thermal calibration value based on spatially grouping thermal sensors according to some embodiments.

### DETAILED DESCRIPTION

As described above, present methods of calibrating thermal sensors to reduce accuracy degradation during functional operation are insufficient. These methods are insufficient because, among other reasons, even small inaccuracies in measurements at lower temperatures can result in large inaccuracy in measurements at higher temperatures of interest, e.g., for triggering a system shutdown or taking some countermeasure based on temperature of digital units (or the entire chip) reaching a particular high temperature.

Most thermal sensors require thermal calibration for accurate readings during a functional mode. A known way of performing this calibration is by forcing a known temperature on the chip surroundings and reducing the power consumption inside the integrated circuit (also referred to as “chip”), such that the temperature inside the chip (T_{junction}) will be equal to the forced temperature (T_{case}). During the calibration, specific values of each thermal sensor are recorded and stored. Those stored values are assigned to each thermal sensor and are then employed during functional operation to improve the accuracy of thermal readings for the thermal sensors.

In certain IC chips or dice in which each thermal sensor relies on a separate analog voltage supply, one technique is to turn off the digital power supply to better control temperature on-die. The assumption is that most of the power consumption comes from the digital units using the digital power supply. After turning off the digital power supply, the entire device power consumption is nearly zero, and hence the junction temperature is nearly the case temperature. This model is simplified as expressed by:

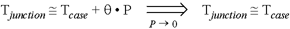

where T_{junction} is the on-die temperature, T_{case} is the environmental temperature (e.g., temperature on both wafer and package-level testing), P is power consumption, and θ is a thermal coupling coefficient. Since the digital domain-based thermal sensors share the same digital power supply with the digital units of the chip, however, it is not possible to turn off the digital power supply. Therefore, calibrating digital thermal sensors requires additional solutions for compensating and controlling T_{junction} during the calibration procedure, e.g., during a calibration mode of operation.

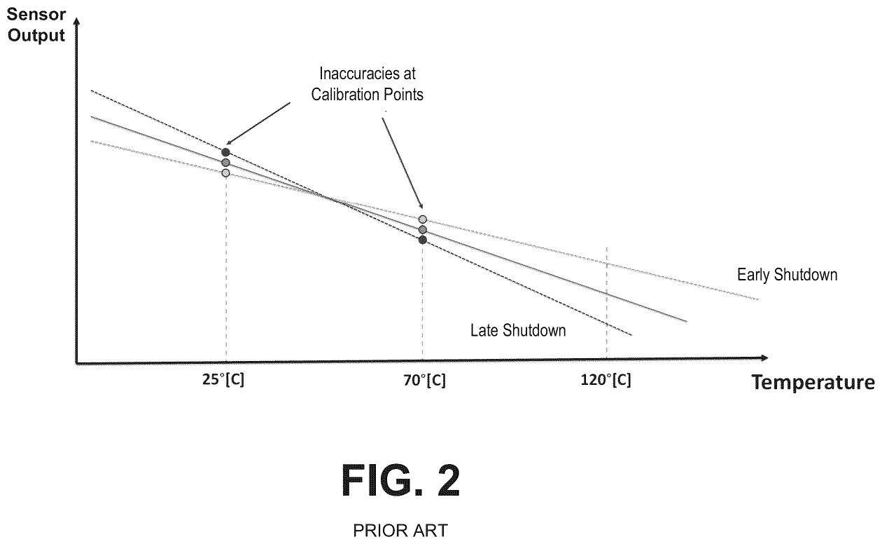

In some scenarios, thermal calibrations are not sufficiently accurate because they are based on certain assumptions, e.g., that the calibration procedure is based on linear proportional-to-absolute-temperature (PTAT) behavior between the thermal sensor results versus actual temperature and that the on-die temperature forced during the calibration is performed accurately. In some such calibration techniques, as illustrated in FIG. 2, a system or device measures two points at two different temperatures (e.g., illustrated are 25 degrees and 70 degrees) and determines the PTAT function of each sensor that assumes to define a curve over all temperature values.

In these calibration techniques, calibration error is mainly caused by the difficulty of keeping both calibration points at the precise temperature on which calibration is assumed. Therefore, small inaccuracies in temperature at measured points during calibration result in large variations in temperature at the extrapolated high temperatures, e.g., at the dangerous, chip-destroying temperatures. As illustrated, inaccurate calibration values can lead to either late shutdown or early shutdown, either of which is undesirable.

In some systems or devices, inaccuracy can stem from an inability to force the particular temperature at which calibration is to be performed. For example, a major source of inaccuracies is leakage or static power dissipation of the digital domain circuitry. In some IC chips or dice, a solution is to turn off the digital power supply and then use only separated analog power supplies. This approach was doable when being able to force the junction temperature to be the case temperature. This approach, however, is not possible or translatable into the digital domain because the digital power supply cannot be turned off. The power dissipation during calibration, therefore, is significantly different than zero. For example, the junction temperature will normally be higher than the case temperature.

Aspects and embodiments of the present disclosure address the above deficiencies with former thermal calibration techniques just outlined by ensuring a zero temperature gradient exists on the die before performing calibration, e.g., thus not requiring power (P) in the above equation be zero. For example, the above equation can be recast for purposes of the below disclosure as:

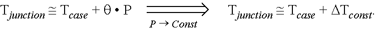

In various embodiments, once the on-die temperature remains approximately constant (e.g., zero temperature gradient), with minimal variation across die areas, calibration diodes are used for accurate analog thermal sensing. In some embodiments, this zero temperature gradient is achieved by deactivating a plurality of digital logic units of digital domain circuitry of the IC chip or die, the chip circuitry is driven by a slower reference clock (compared to the chip clock) provided by a tester unit, and a constant on-die temperature is achieved before calibration is performed. Although parts of the die or chip may have different temperatures, a change in temperature of any particular area of the die can be substantially eliminated before calibration.

In the inaccuracies of generating a PTAT function, the thermal lines of FIG. 2 can often have a non-ideal curvature, either in an up or down direction. These non-idealities, however, can be practically eliminated by averaging deviations from the exact temperature across thermal sensors. In some embodiments, such averaging is performed by spatially grouping arrays of thermal sensors into subsets of thermal sensors based on proximity. A sufficient number of thermal sensors in each subset may enable averaging to a more accurate temperature value while being located in a geographically small enough area that differences in actual temperature across the geographic area are also small. Thus, once determining a spatially average thermal value for the subset of thermal sensors, each thermal sensor of the subset can be programmed (e.g., via an e-fuse register) to operate based on the same averaged thermal value during functional operation of the IC chip or die.

Therefore, advantages of the IC chips, dice, systems, and methods implemented in accordance with some embodiments of the present disclosure include, but are not limited to, establishing the conditions for zero temperature gradient that enable accurate temperature readings by thermal sensors in proximity to a calibration diode. Additional advantages include increasing the accuracy of thermal calibrated values by spatially grouping thermal sensors and determining average thermal values for each subset (or group) of thermal sensors. Other advantages will be apparent to those skilled in the art of thermal sensor design and calibration within digital domains, as will be discussed hereinafter.

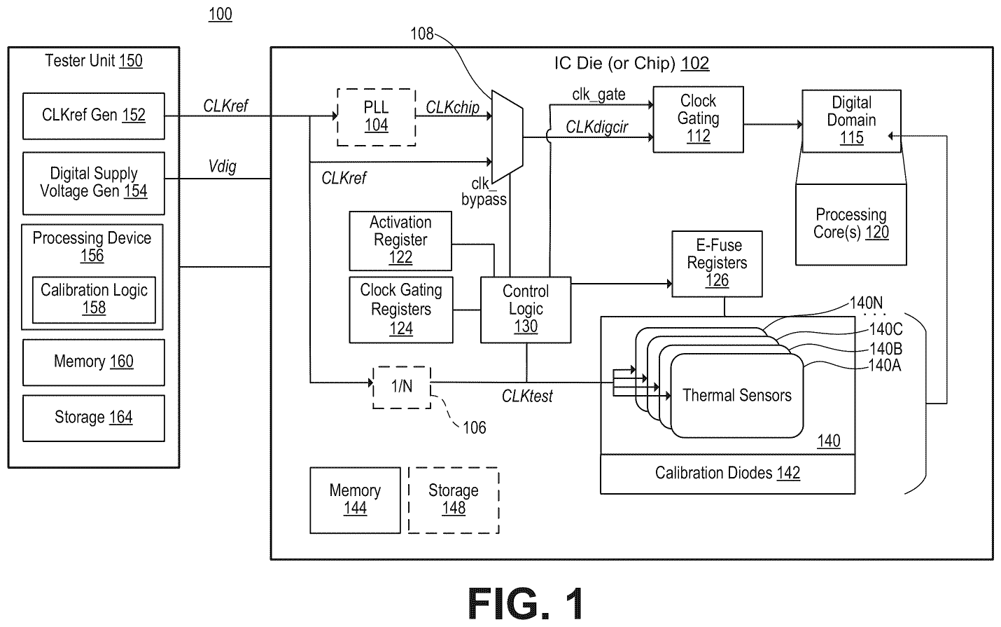

FIG. 1 is a schematic block diagram of an example thermal testing system 100 implementing low activity, spatial calibration for full digital domain thermal sensors according to various embodiments. In various embodiments, the system 100 includes an IC die 102 (or IC chip) to be calibrated for temperature, and a tester unit 150 that can be coupled to the IC die 102 to aid in the temperature calibration. In at least some embodiments, the IC die 102 (or IC chip) is or include a central processing unit (CPU), a graphics processing unit (GPU), or a data processing unit (DPU).

In at least some embodiments, the IC die 102 includes an optional phase-locked loop (PLL) 104, a clock divider 106, a clock-bypass multiplexer 108, clock gating circuitry 112 coupled to digital domain circuitry 115, one or more processing cores 120, memory 144, and optional storage 148. In some embodiments, the processing core(s) 120 include at least a portion of the digital domain circuitry 115. In these embodiments, the IC die 102 also includes an activation register 122, clock gating registers 124, e-fuse registers 126, and control logic 130.

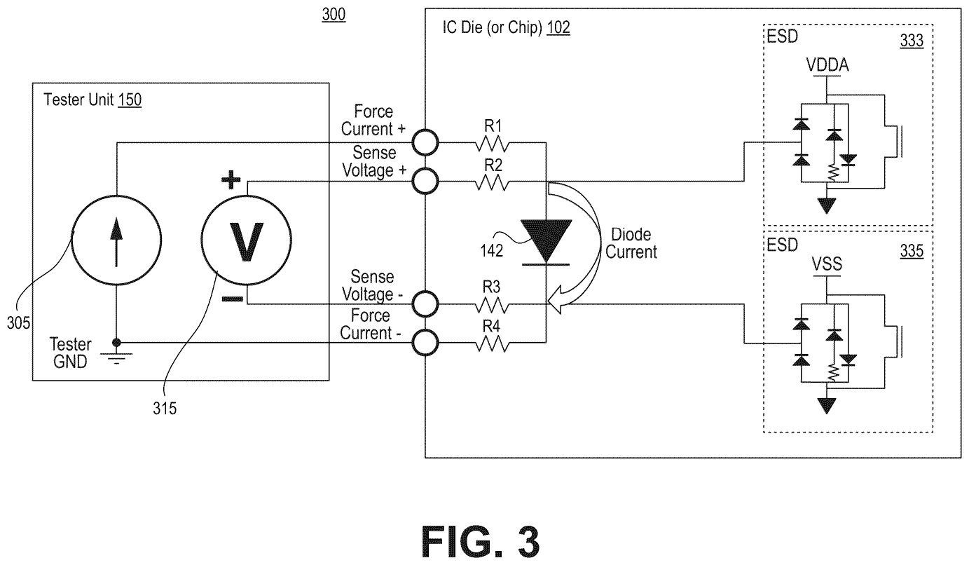

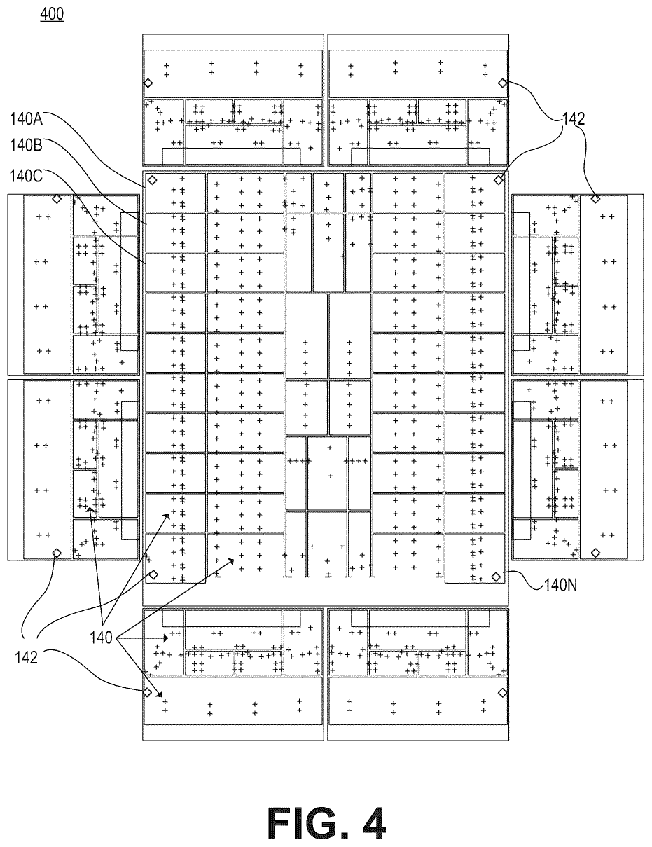

In at least some embodiments, the IC die 102 also includes a plurality of thermal sensors 140 and a plurality of calibration diodes 142. In various embodiments, the plurality of thermal sensors 140 and the plurality of calibration diodes 142 are integrated within the digital domain circuitry 115 across the IC die 102 (see FIG. 4). In some embodiments, the control logic 130 is integrated within one of the processing core(s) 120. In some embodiments, the calibration diodes 142 are coupled to the tester unit 150 and the control logic 130 and are useable for accurate thermal sensing during the thermal calibration mode, as will be discussed in more detail with reference to FIG. 3.

In at least some embodiments, the tester unit 150 includes a reference clock generator 152 to generate a reference clock (CLKref) useable by the IC die 102 during a calibration mode, a digital supply voltage generator 154 to generate a digital supply voltage (Vdig) for use by the IC die 102 during the calibration mode, a processing device 156 including calibration logic 158 (although the calibration logic 158 may also exist outside of the processing device 156), memory 160, and storage 164. In some embodiments, the storage 164 includes instructions that are executable by the processing device 156 out of the memory to perform functions encoded as the calibration logic 158. In some embodiments, the calibration logic 158 is at least partially instantiated as hardware logic.

This disclosure changes the perspective of thermal calibration in not requiring a minimum power dissipation to be met during calibration. Instead, in some embodiments, calibration is performed during a mode in which a zero temperature gradient is achieved on-die. In various embodiments, this zero temperature gradient is achieved by a particular clocking architecture, which disables the digital domain circuitry 115, and by supplying a digital voltage supply (Vdig) for use by the IC die 102 during calibration, as will be discussed in more detail.

In at least some embodiments, the calibration logic 158 writes activation data to the activation register 122, which causes the IC die 102 to enter a thermal calibration mode. In these embodiments, the thermal calibration mode activates the control logic 130 that controls and coordinates the on-die activity that will carry out the thermal calibration, in part through interaction with the tester unit 150, as will be explained.

In various embodiments, the reference clock (CLKref) generated by the tester unit 150 is supplied to the PLL 104, the clock-bypass multiplexer 108, and the clock divider 106. In at least some embodiments, the digital domain circuitry 115 runs off of a clock at the same speed as the reference clock, in which case the control logic 130 sends a clock-bypass signal to the clock-bypass multiplexer 108, causing the reference clock to be passed to the clock gating circuitry 112.

In other embodiments, the digital domain circuitry 115 runs off a higher-speed clock than the reference clock. In these embodiments, the PLL 104 generates a chip clock (CLKchip) to drive the digital domain circuitry 115, so the clock-bypass multiplexer 108 passes the chip clock to the clock gating circuitry 112. In at least some embodiments, the speed of the reference clock is less than that of the chip clock, e.g., it may be tens to a hundred (or more) times slower than the chip clock. Whether the reference clock or a higher-speed chip clock, the clock provided to the clock gating 112 can be understood as a digital circuitry clock (CLKdigdir) that drives the digital domain circuitry 115, including the processing core(s) 120.

In some embodiments, the tester unit 150 (e.g., the calibration logic 158) writes clock-gating data to one or more clock-gating registers 124 to cause deactivation of a plurality of digital logic units of the digital domain circuitry 115. For example, in at least one embodiment, in response to reading the clock gating data from the one or more clock gating registers 124, the control logic 130 causes the reference clock to drive the plurality of thermal sensors 140 and deactivates a plurality of digital logic units of the digital domain circuitry 115.

For example, the clock gating circuitry 112 can be coupled between the tester unit 150 and the digital domain circuitry 115. In at least one embodiment, to deactivate the plurality of digital logic units, the control logic 130 controls or otherwise triggers the clock gating circuitry 112 to block the reference (or chip) clock from reaching the plurality of digital logic units. In some embodiments, controlling the clock gating circuitry 112 in this way does not turn off digital units that provide inter-die or inter-chip communication, which may still be needed to communicate with the plurality of thermal sensors 140 and the plurality of calibration diodes 142 in performing the thermal calibration. The ability to selectively turn off (or deactivate) the majority of the digital units of the digital domain circuitry 115 enables a significant reduction of dynamic power dissipation, enabling moving toward an on-die zero temperature gradient. In other words, the majority of power dissipation that remains is static, e.g., from digital power supply leakage, and can stabilize after the IC die 102 has passed some time in operation. Further, where the transistor density on digital units is approximately the same, the entire digital domain can trend towards the same temperature in some embodiments.

In some embodiments, the control logic 130 determines that a time period has elapsed of a sufficient length that a temperature of the IC die 102 (or IC chip) has stabilized. The control logic 130 may also record or store (e.g., in the e-fuse registers 126) calibrated temperature values from the plurality of calibration diodes 142 and calibrated thermal values from the plurality of thermal sensors 140 obtained during the calibration mode. In other embodiments, these calibrated temperature values from the plurality of calibration diodes 142 and calibrated thermal values from the thermal sensors 140 are provided to the tester unit 150 to be stored in the memory 160 and/or the storage 164.

In various embodiments, either the control logic 130 (of the IC die 102) or the calibration logic 158 (of the tester unit 150), retrieves these values to generate a linear temperature equation between sensor output and actual temperature for each thermal sensor, or as will be discussed, for each subset of the thermal sensors 140. In some embodiments, the control logic 130 and/or the calibration logic 158 (together “logic” herein) may then reference this linear temperature equation to determine an actual temperature value based on one or more thermal sensor outputs during a functional mode of operation of the IC die 102.

In various embodiments, the clock divider 106 is coupled between the tester unit 150 and the plurality of thermal sensors 140. In these embodiments, the clock divider 106 generates a test clock (CLKtest) from the reference clock. In some embodiments, the test clock is of a lower speed than that of the reference clock. In some embodiments, the plurality of thermal sensors 140 and the control logic 130 (among other calibration circuitry, including the registers) are driven by the test clock (CLKtest).

In some embodiments, the plurality of e-fuse registers 126 are coupled to the plurality of thermal sensors 140. In these embodiments, the logic writes calibrated thermal values to the plurality of e-fuse registers 126 for use by the plurality of thermal sensors 140 during functional mode, e.g., operational mode after thermal calibration.

In some embodiments, the logic groups a subset of the plurality of thermal sensors according to proximity to generate a plurality of subsets of thermal sensors, e.g., a first subset 140A, a second subset 140B, a third subset 140C, and so forth through to an Nth subset 140N of the plurality of thermal sensors 140. In these embodiments, the logic determines a spatially average temperature value of the subset, which can be repeated for each subset of thermal sensors. In these embodiments, the logic further employs the spatially average temperature value to thermally calibrate the subset using a calibrated temperature value measured by a calibration diode 142 located closest to the subset.

FIG. 3 is a schematic block diagram of an example system architecture 300 for reading thermal calibration diodes 142 according to at least some embodiments. In some embodiments, the system architecture 300 is based on the thermal testing system 100 discussed with reference to FIG. 1. In some embodiments, the tester unit 150 includes a current source 305 (which can be the digital supply voltage generator 154 in some embodiments) and a voltage sensor 315. In some embodiments, the tester unit 150 includes many different, independent current and voltage sources.

In various embodiments, the IC die 102 includes the plurality of calibration diodes 142, of which one calibration diode 142 is illustrated for purposes of explanation. In embodiments, the IC die 102 further includes a first resistor (R1) coupled between a positive terminal of the current source 305 and that of the calibration diode 142, a second resistor (R2) coupled between the positive terminal of the voltage source 315 and that the calibration diode 142, a third resistor (R3) coupled between ground (e.g., negative terminal) of the voltage sensor 315 and that of the calibration diode 142, and a fourth resistor (R4) coupled between the ground (e.g., negative terminal) of the current source 305 and that of the calibration diode 142. In some embodiments, resistors R1, R2, R3, and R4 represent parasitic resistance in routing, and thus is implicit resistors rather than designed resistors. In these embodiments, the IC die 102 further includes a first electrostatic discharge (ESD) circuit 333 coupled between the positive terminal of the calibration diode 142 and the digital power supply (VDDA) and a second ESD circuit 335 coupled between the negative terminal of the calibration diode 142 and the ground (VSS).

In some embodiments, the calibration diode 142 is an analog component having a p-type/n-type (PN) junction that provides a way to perform an accurate Kelvin measurement. For example, current may be forced through the first resistor, the calibration diode 142, and the fourth resistor. Subsequently, or concurrently, the voltage sensor 315 senses the voltage through the second resistor, the calibration diode 142, and the third resistor. This type of Kelvin measurement may eliminate the non-idealities within routing from the tester unit 150 to the calibration diode 142. In some embodiments, the exponential current-voltage nature of the calibration diode 142, in which the voltage across the PN junction and the junction temperature are coupled, enables the tester unit 150 to accurately estimate the junction temperature, otherwise referred to herein as a calibration temperature value. In other words, the voltage across the calibration diode 142 at a certain current is linear with temperature.

In some embodiments, the logic uses the junction temperature (e.g., calibration temperature value) of the calibration diode with calibrated thermal values read out of the plurality of thermal sensors 140 during calibration (e.g., that were stored in the e-fuse registers 126 or the memory 160) to determine a linear temperature function for each thermal sensor or subset of thermal sensors. The logic may then employ the linear temperature function to adjust the temperature readings of the thermal sensors 140 accordingly during the functional mode, e.g., determine an actual temperature based on the thermal values read out of the thermal sensors 140.

Each calibration diode 142 has a generic equation according to the following model:

$${I}_{D} = {I}_{0} \cdot ( {e}^{\frac{q \cdot {V}_{D}}{n \cdot kT}} - 1 )$$

This equation is calibrated after post-silicon characterization per the silicon process employed in order to calibrate the thermal sensors 140 nearest to the calibration diode 142.

FIG. 4 is a simplified schematic block diagram of an example set of IC dice 400 together with a spatial grouping of thermal sensors 140 and associated calibration diodes 142 according to at least some embodiments. In various embodiments, each IC die 102 or chip includes the plurality of thermal sensors 140 (marked as a +) distributed throughout the digital domain circuitry 115, the latter of which is not illustrated for purposes of simplicity of illustration. In these embodiments, each IC die 102 or chip also includes the plurality of calibration diodes 142.

High-end and modern communication systems are anticipated to have a considerable chip area. In such systems, if each digital thermal sensor 140 is small enough in area and easily integrated, a large number of the thermal sensors 140 may be instantiated over the chip area in negligible integration effort. Moreover, on the full chip level, one can determine that each digital unit will be integrated with one or more thermal sensors 140. Since the number of thermal sensors may be larger than the required thermal spatial resolution, the array of sensors can be divided into local groups or subsets of thermal sensors 140. In this way, an effective spatial resolution is defined for a particular thermal solution on the full chip level.

In some embodiments, as illustrated in FIG. 4, the set of IC dice 400 includes a main die (in the middle) and eight auxiliary dice coupled around a periphery of and to the main die, although different dice arrangements are envisioned. Each die or all of the dice as a group may be comparable to the IC die 102 or IC chip discussed with reference to FIG. 1. For example, not all of these dice need to be calibrated at the same time. The main die can be calibrated with other main dice at the wafer level or may be calibrated alone. Each of the other dice can be calibrated alone or together with others of the auxiliary dice. Also, within a single die, the control logic 130 can activate one group or multiple groups of thermal sensors at a time. In some embodiments, the control logic 130 can activate one or many thermal sensors at a time, including individual subsets of the thermal sensors 140.

As was discussed, the IC die 102 may be segmented into a plurality of subsets of thermal sensors, each subset being in relative proximity. Only by way of example, this plurality of subsets may include a first subset 140A, a second subset 140B, a third subset 140C, and so forth through to an Nth subset 140N of the plurality of thermal sensors 140. Further, each subset may also be associated with a nearest or closest calibration diode 142 In some embodiments, the logic determines and stores a calibration temperature value (e.g., juncture temperature value) in the e-fuse registers 126 (or the memory 160 and/or the storage 164) in relation to each subset of the thermal sensors 140, e.g., 140A . . . 140N. This calibration temperature value may then be used during the functional mode to map an output of a respective subset of the thermal sensors 140 to an actual temperature.

In some embodiments, grouping the thermal sensors 140 is predefined based on a thermal simulation performed pre-silicon before tape out. In some embodiments, the grouping of thermal sensors 140 as a subset does not require some arbitrary minimum or maximum number of sensors, but rather, it may be based on topology analysis in which nearby sensors are grouped together in a logical way. For example, a sufficient number of thermal sensors in each subset may enable averaging to a more accurate temperature value while being located in a geographically small enough area that differences in actual temperature across the geographic area are also small. Geographic relevance may be encouraged due to some temperature and process variations across a die or chip.

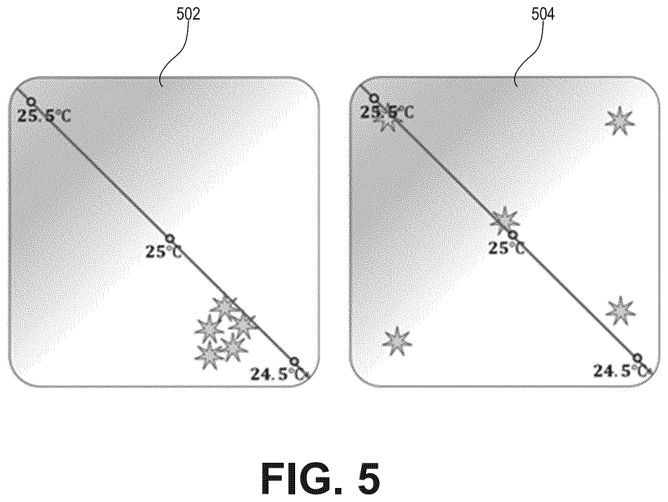

FIG. 5 is a pair of graphs illustrating the motivation for spatially grouping sensors in particular ways according to various embodiments. It is known that silicon mass production comes with significant non-idealities. Each analog component may suffer from mismatches in many physical parameters, which can slightly change its analog behavior. Non-idealities such as global process corner and local process mismatches might be significant error contributors to the accuracy of analog thermal sensors. A significant part of the non-idealities of each sensor is calibrated under the assumption of linear dependency in temperature (as described above), but some non-idealities can make the thermal sensor deviate from a linear temperature dependence and degrade the accuracy of the thermal sensor.

In various embodiments, the disclosed logic employs a technique in which a standalone sensor does not dictate a thermal or temperature value reading, but a thermal value of a group of a few sensors is averaged, effectively filtering out a major part of the error. In fact, where each parameter is randomly distributed (in a probability density function) with an average value of zero, any standard deviation may be reduced proportionally by the size of the group or subset of thermal sensors, e.g., 140N.

As described above, additional error contributors may come from the calibration error itself, e.g., the uncertainty in T_{junction} (of a calibration diode) during the calibration. The disclosed calibrating scheme can put the device of system under conditions in which one can assume approximately zero temperature gradient. This assumption is valid to a statistically relevant degree. The global chip area is indeed turning into a zero-temperature gradient mode, but there are still local temperature fluctuations in the unit level, e.g., from digital unit to digital unit throughout the IC die 102.

In the example of FIG. 5, a local temperature gradient of 1° C. is illustrated for two different averaging options: local averaging and spatial averaging. Assuming that in both options the calibration diode is showing a calibration temperature of 25° C., a subset of thermal sensors 502 (on the left) would suffer from a 0.5° C. calibration error, while a subset of thermal sensors 504 (on the right) would have on average no calibration error. As described above, a small calibration error is extrapolated to a large functional error at high temperatures. The size of the group is small enough for a thermal pixel resolution, e.g., a thermal value for a given subset of thermal sensors, and yet large enough to eliminate the described problem with reference to the subset of thermal sensors 502. Between groups, there should not be a significant variance in average temperature. Employing the average temperature in each respective group for use in the operational mode can result in a high level of accuracy.

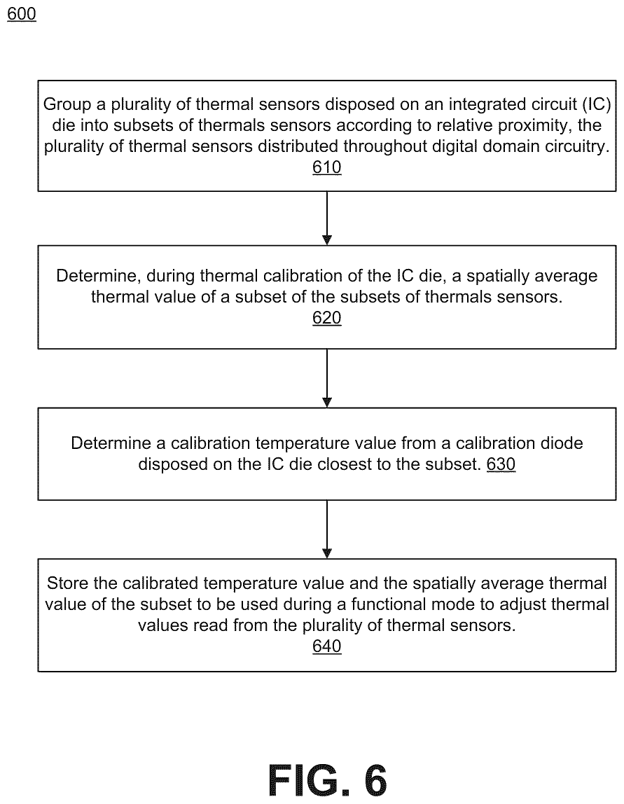

FIG. 6 is a flow chart of an example method 600 for determining a thermal calibration value based on spatially grouping thermal sensors according to some embodiments. The method 600 can be performed by processing logic comprising hardware, software, firmware, or any combination thereof. For example, the method 600 can be performed by the control logic 130 on the IC die 102 and/or by the calibration logic 158 on the tester unit 150 (see FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic groups a plurality of thermal sensors 140 disposed on an integrated circuit (IC) die into a plurality of subsets of thermal sensors according to relative proximity. In some embodiments, the plurality of thermal sensors 140 are distributed throughout digital domain circuitry 115 of the IC die 102. In some embodiments, grouping the plurality of thermal sensors 140 into the plurality of subsets comprises determining a range of thermal sensors, a number of which is sufficient to provide an accurate spatially average thermal value for a chip area covered by each subset.

At operation 620, the processing logic determines, during thermal calibration of the IC die, a spatially average thermal value of a subset of the plurality of subsets of thermals sensors. In one embodiment, the spatially average thermal value is determined by activating one or more thermal sensors 140 of the subset at a time and recording a temperature value for each of the one or more thermal sensors. In another embodiment, the processing logic concurrently activates the thermal sensors of the subset and concurrently records the thermal values for each thermal sensor. It is also possible to concurrently activate the thermal sensors of many (or all) of the subsets of thermal sensors in the IC die 102 or chip.

At operation 630, the processing logic determines a calibration temperature value from a calibration diode 142 disposed on the IC die closest to the subset of thermal sensors.

At operation 640, the processing logic stores the calibrated temperature value and the spatially average thermal value of the subset to be used during a functional mode to adjust thermal values read from the plurality of thermal sensors.

In some embodiments of the method 600, the processing logic further stores the calibrated temperature value in a first e-fuse register and the spatially average thermal value of the subset in a second e-fuse register for use by the subset during a functional mode of operating the IC die. In some embodiments, during a functional mode of operation of the IC die 102, the processing logic further reads the calibrated temperature value from the first e-fuse register and the spatially average thermal value from the second e-fuse register. In these embodiments, the processing logic determines, from a combination of the spatially average thermal value and the calibrated temperature value, an individual calibrated thermal value for calibrating each thermal sensor of the subset.

During functional mode, the disclosed thermal calibration techniques gain a significant advantage due to spatial averaging of the thermal values read by the thermal sensors. Since the thermal mapping during functional mode is coming from a group of sensors and not from a stand-alone sensor, the accuracy of each thermal read is highly enhanced.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. An integrated circuit comprising:
a plurality of thermal sensors integrated within digital domain circuitry and powered by a digital supply voltage;
an activation register to receive activation data from a tester unit; and
control logic coupled to a tester unit, the plurality of thermal sensors, and the activation register, wherein the control logic is to:
in response to the activation register being written with the activation data, enter a thermal calibration mode;
deactivate a plurality of digital logic units of the digital domain circuitry; and
cause a reference clock received from the tester to drive the plurality of the thermal sensors.

2. The integrated circuit of claim 1, further comprising a phase-locked loop (PLL) coupled to the digital domain circuitry, the PLL to:
receive the reference clock from the tester unit; and
generate a chip clock that is to drive the digital domain circuitry, wherein a speed of the reference clock is less than that of the chip clock.

3. The integrated circuit of claim 1, further comprising:
the digital domain circuitry; and
clock gating circuitry coupled between the tester unit and the digital domain circuitry, wherein to deactivate the plurality of digital logic units, the control logic is to control the clock gating circuitry.

4. The integrated circuit of claim 1, further comprising a clock divider coupled between the tester unit and the plurality of thermal sensors, the clock divider to generate a test clock from the reference clock, the test clock of a lower speed than that of the reference clock, wherein the plurality of thermal sensors and the control logic are driven by the test clock.

5. The integrated circuit of claim 1, further comprising a plurality of calibration diodes integrated within the plurality of thermal sensors and coupled to the control logic, the plurality of calibration diodes useable for accurate thermal sensing during the thermal calibration mode.

6. The integrated circuit of claim 5, further comprising a plurality of e-fuse registers coupled to the control logic, wherein the control logic is further to:
determine that a time period has elapsed of a sufficient length that a temperature of the integrated circuit has stabilized; and
store, in the plurality of e-fuse registers, calibrated temperature values determined from the plurality of calibration diodes for adjusting thermal values read from corresponding thermal sensors of the plurality of thermal sensors during a functional mode.

7. The integrated circuit of claim 1, further comprising a plurality of e-fuse registers coupled to the plurality of thermal sensors and the control logic, wherein the control logic is further to store, in the plurality of e-fuse registers, calibrated thermal values from the plurality of thermal sensors for adjusting thermal values read from the plurality of thermal sensors during a functional mode.

8. The integrated circuit of claim 1, wherein the control logic is further to:
group a subset of the plurality of thermal sensors according to proximity;
determine a spatially average temperature value of the subset; and
employ the spatially average temperature value to thermally calibrate the subset relative to a calibrated thermal value measured by a calibration diode located closest to the subset.

9. A system comprising;
an integrated circuit (IC) die comprising:
a plurality of thermal sensors integrated within digital domain circuitry; and
an activation register and one or more clock-gating registers; and
a tester unit coupled to the IC die to perform thermal calibration of the IC die, the tester unit to generate a reference clock and a digital supply voltage for the IC die, wherein the tester unit comprises calibration logic to:
write activation data to the activation register that causes the IC die to enter a thermal calibration mode; and
write clock-gating data to the one or more clock-gating registers to cause deactivation of a plurality of digital logic units of the digital domain circuitry.

10. The system of claim 9, wherein the IC die further comprises a phase-locked loop (PLL) coupled to the digital domain circuitry, the PLL to:
receive the reference clock from the tester unit; and
generate a chip clock that is to drive the digital domain circuitry, wherein a speed of the reference clock is less than that of the chip clock.

11. The system of claim 9, wherein the IC die further comprises control logic coupled to the tester unit and the plurality of thermal sensors, the control logic to, in response to entering the thermal calibration mode:
cause the reference clock to drive the plurality of the thermal sensors; and
deactivate a plurality of digital logic units of the digital domain circuitry in response to reading the clock-gating data from the one or more clock-gating registers.

12. The system of claim 9, wherein the IC die further comprises:
the digital domain circuitry;
control logic coupled to the tester unit; and
clock gating circuitry coupled between the tester unit and the digital domain circuitry, wherein to deactivate the plurality of digital logic units, the control logic is to control the clock gating circuitry.

13. The system of claim 9, wherein the IC die further comprises:
control logic coupled to the tester unit; and
a clock divider coupled between the tester unit and the plurality of thermal sensors, the clock divider to generate a test clock from the reference clock, the test clock of a lower speed than that of the reference clock, wherein the plurality of thermal sensors and the control logic are driven by the test clock.

14. The system of claim 9, wherein the IC die further comprises:
a plurality of e-fuse registers; and
a plurality of calibration diodes integrated within the digital domain circuitry; and
wherein the calibration logic is further to:
determine that a time period has elapsed of a sufficient length that a temperature of the IC die has stabilized; and
store, in the plurality of e-fuse registers, calibrated temperature values determined from the plurality of calibration diodes for adjusting thermal values read from corresponding thermal sensors of the plurality of thermal sensors during a functional mode.

15. The system of claim 9, wherein the IC die further comprises a plurality of e-fuse registers coupled to the plurality of thermal sensors, wherein the calibration logic is further to store, in the plurality of e-fuse registers, calibrated thermal values from the plurality of thermal sensors for adjusting thermal values read from the plurality of thermal sensors during a functional mode.

16. The system of claim 9, wherein the calibration logic is further to:
group a subset of the plurality of thermal sensors according to proximity;
determine a spatially average temperature value of the subset; and
employ the spatially average temperature value to thermally calibrate the subset relative to a calibrated thermal value measured by a calibration diode located closest to the subset on the IC die.

17. A method comprising:
grouping a plurality of thermal sensors disposed on an integrated circuit (IC) die into a plurality of subsets of thermals sensors according to relative proximity, the plurality of thermal sensors distributed throughout digital domain circuitry of the IC die;
determining, during thermal calibration of the IC die, a spatially average thermal value of a subset of the plurality of subsets of thermals sensors;
determining a calibrated temperature value from a calibration diode disposed on the IC die closest to the subset; and
storing the calibrated temperature value and the spatially average thermal value of the subset to be used during a functional mode to adjust thermal values read from the plurality of thermal sensors.

18. The method of claim 17, wherein storing comprises storing the calibrated temperature value in a first e-fuse register and storing the spatially average thermal value in a second e-fuse register, wherein the method further comprises, during a functional mode:
reading the calibrated temperature value from the first e-fuse register and the spatially average thermal value from the second e-fuse register; and
determining, from a combination of the spatially average thermal value and the calibrated temperature value, an individual calibrated thermal value for calibrating each thermal sensor of the subset during a functional mode of operating the IC die.

19. The method of claim 17, wherein determining the spatially average thermal value comprises one of:
activating one or more thermal sensors of the subset at a time and recording a thermal value for each of the one or more thermal sensors; or
concurrently activating the thermal sensors of the subset and concurrently recording the thermal values for each thermal sensor.

20. The method of claim 17, wherein grouping the plurality of thermal sensors into the plurality of subsets comprises determining a range of thermal sensors, a number of which is sufficient to provide an accurate spatially average thermal value for a chip area covered by each subset.
